(19) United States
(12) Patent Application Publication
(10) Pub. No.: US 2022/0374923 A1
(43) Pub. Date: Nov. 24, 2022

(54) COMPUTATIONAL METHODS AND PROCESSOR SYSTEMS FOR PREDICTIVE MARKETING ANALYSIS

(71) Applicant: Forethought Pty Ltd, Melbourne (AU)

(72) Inventors: Kenneth George Roberts, Travancore (AU); Carissa Cater, Monegeetta (AU); Antony Perera, Berwick (AU)

(21) Appl. No.: 17/869,502

(22) Filed: Jul. 20, 2022

Related U.S. Application Data
(63) Continuation of application No. 17/030,890, filed on Sep. 24, 2020.
(60) Provisional application No. 62/915,991, filed on Oct. 16, 2019.

(30) Foreign Application Priority Data
Sep. 25, 2019 (AU) 2019903573

(51) Int. Cl. G06Q 30/02

(52) U.S. Cl. CPC G06Q 30/0201; G06Q 30/0206; G06Q 30/0242

(57) ABSTRACT

A computer-implemented method of predicting changes in market share comprises computing coefficients of a first statistical model corresponding with first market research survey data relating to rational and emotional drivers of consumer choice. Each coefficient represents a relative impact of an associated driver. Predicted changes in attributes of the target brand are computed based on the first statistical model, using second market research survey data relating to consumer response. A predicted efficacy measure is computed using the predicted changes in attributes of the target brand and current market share data. A modified efficacy measure is computed based on the predicted efficacy measure, a measure of communications media efficiency, a measure of consumer recognition, and a measure of consumer linkage to the target brand. The modified efficacy measure is used with financial factor data to compute one or more measures of commercial outcome from the marketing communications campaign.

### CROSS-REFERENCE TO RELATED APPLICATIONS

This application is a continuation of U.S. patent Application Ser. No. 17/030,890, entitled COMPUTATIONAL METHODS AND SYSTEMS FOR MARKETING ANALYSIS, filed Sep. 24, 2020, which claims priority to U.S. Provisional Patent Application No. 62/915,991, entitled COMPUTATIONAL METHODS AND SYSTEMS FOR IMPROVED PREDICTION OF COMMERCIAL OUTCOMES FROM MARKETING COMMUNICATIONS, filed Oct. 16, 2019, and to Australian Provisional Patent application No. AU 2019 903573, filed Sep. 25, 2019, each of which is incorporated by reference herein, in the entirety and for all purposes.

### FIELD

The present invention relates generally to data modeling, and more particularly to computational methods, systems and computer program products with executable code stored on a non-transitory, computer-readable medium, configured to perform modeling and analytics using market research and marketing activity data and able to predict the impact of communications on market share and commercial outcomes.

### BACKGROUND

Businesses spend significant sums on marketing communications, i.e. advertising, in their efforts to maintain and grow the size and share of the markets for their goods and services. In 2018, according to data published by Publicis Groupe's data unit Zenith, global advertising expenditure was nearly US $600 billion. Of this, around US $125 billion was spent in the US alone, equivalent to around 0.6% of GDP. Naturally, businesses would like to understand the effectiveness of this investment. Better yet, they would like to be able to predict, in advance, the expected effectiveness of marketing communications in achieving business objectives, such as enhanced profitability.

It is widely recognized that one of the main determinants of business profitability is market share, with those enterprises that have achieved a high level of market share within the market sectors in which they compete being generally more profitable than their smaller-share rivals.

There is, accordingly, an ongoing need for improved computational methods and systems, having a sound basis in marketing science, data science, modeling and analytics, for measuring the performance of marketing communications, and for predicting the corresponding impact on market share and associated commercial outcomes, such a profitability. Embodiments of the present invention are directed to addressing this need.

### SUMMARY

In one aspect, the invention provides a computing system for predicting changes in market share responsive to a marketing communications campaign associated with a target brand. The computing system comprises: a processor; at least one memory device accessible by the processor; and at least one market research data store accessible by the processor; e.g., where the memory device contains a non-transitory, computer-readable data storage medium with program instructions stored thereon which, when executed by the processor, cause the computing system to implement a marketing analytics system.

The system can comprise one or more of a multivariate statistical analysis module configured to retrieve, from the market research data store, first market research survey data relating to rational and emotional drivers of consumer choice, and to compute a corresponding first plurality of coefficients of a first statistical model; e.g. where each coefficient represents a relative impact of an associated driver of consumer choice; a test response analysis module configured to retrieve, from the market research data store, second market research survey data relating to consumer response to marketing communications content that has been developed based upon leading drivers of consumer choice identified from the coefficients of the first statistical model, and to use the first statistical model and second market research survey data to compute predicted changes in attributes of the target brand corresponding with the leading drivers of consumer choice resulting from the marketing communications content; a market share simulation module configured to compute, using the predicted changes in attributes of the target brand and current market share data, a predicted efficacy measure of the marketing communications content in changing market share of the target brand; and a return on investment (ROI) modeling module configured to compute a modified efficacy measure, based upon the predicted efficacy measure, a measure of communications media efficiency, a measure of consumer recognition of the marketing communications content, and a measure of consumer linkage of the marketing communications content to the target brand, and to use the modified efficacy measure along with provided financial factor data to compute one or more measures of commercial outcome from the marketing communications campaign.

The measures of commercial outcome can be represented on a graphical interface in communication with the processor. The interface can be configured for the user to interact with the market share module or the ROI modeling modules, or both, or any combination of the processor, market research data store, multivariate statistical analysis module, test response analysis module, and the market share and ROI modeling modules.

Advantageously, embodiments of the invention thereby provide a more comprehensive account and prediction of the in-market performance of marketing communications than has previously been available. From end-to-end: rational and emotional drivers of consumer choice are identified; the efficacy of marketing communications based upon identified lead drivers is measured; predicted changes in consumer preferences are determined; the expected impact of the proposed marketing campaign is assessed, taking into account realistic assumptions in relation to recognition, linkage and media efficiency; and predictions are made of commercial outcomes. These predictions can be used to assist in making business decisions, such as whether or not to proceed with the proposed campaign, based upon commercial outcomes such as whether or not the campaign is expected to produce a sufficient return on investment.

In embodiments of the invention, the predicted efficacy measure is a numerical value η, the measure of consumer recognition is a numerical value γᵣ, the measure of consumer linkage of the marketing communications content to the target brand is a numerical value γₗ, the measure of communications media efficiency is a numerical value μₑ, and the modified efficacy is a numerical value η′ which is computed according to the formula:

η′=(η×γᵣ×γₗ)×μₑ.

The communications media efficiency value μₑ may be computed using a media mix modeling algorithm.

The first statistical model may comprise a hierarchical Bayesian model, and the consumer choice may be represented as the dependent variable of the hierarchical Bayesian model, and may comprise a consumer first choice (FC) selection derived from the first market research survey data.

The provided financial factor data may comprise one or more of: weighted average cost of capital (WACC); inflation rate; taxation rates; an investment amount associated with achieving the increase in market share; campaign duration; campaign ramp-up period; and a measure of expected increase in revenues associates with an increase in market share. The measures of commercial outcome from the marketing communications campaign may comprise one or more of: net present value (NPV); internal rate of return (IRR); and payback period.

In embodiments of the invention, the multivariate statistical analysis module may be further configured to retrieve, from the market research data store, consumer value assessment data, and to compute a second plurality of coefficients of a second statistical model; e.g., where each coefficient represents a relative impact of an associated attribute of the target brand on consumer value assessment. The second statistical model may comprise a linear regression model, and the consumer value assessment may be represented as the dependent variable of the linear regression model, and may comprise a consumer worth-what-is-paid (WWP) response derived from the first market research survey data.

In embodiments of the invention, the program instructions further include instructions implementing a client interface module configured to enable a user to interact with the market share simulation module and the ROI modeling module via a graphical interface of a client terminal.

In another aspect, the invention provides a computer-implemented method of predicting changes in market share responsive to a marketing communications campaign associated with a target brand. The method can be implemented with one or more steps of: retrieving, from a market research data store, first market research survey data relating to rational and emotional drivers of consumer choice; computing a first plurality of coefficients of a first statistical model corresponding with the first market research survey data, e.g., where each coefficient represents a relative impact of an associated driver of consumer choice; retrieving, from the market research data store, second market research survey data relating to consumer response to marketing communications content that has been developed based upon leading drivers of consumer choice identified from the coefficients of the first statistical model; computing, using the first statistical model and second market research survey data, predicted changes in attributes of the target brand corresponding with the leading drivers of consumer choice resulting from the marketing communications content; computing, using the predicted changes in attributes of the target brand and current market share data, a predicted efficacy measure of the marketing communications content in changing market share of the target brand; computing a modified efficacy measure, based upon the predicted efficacy measure, a measure of communications media efficiency, a measure of consumer recognition of the marketing communications content, and a measure of consumer linkage of the marketing communications content to the target brand; and computing, using the modified efficacy measure along with provided financial factor data, one or more measures of commercial outcome from the marketing communications campaign.

The measures of commercial outcome can be represented on a graphical interface in communication with the processer, and adapted to receive user input as described herein. In another aspect, the invention provides a computer program product comprising a tangible, non-transitory computer-readable medium having instructions stored thereon which, when executed by a processor implement a method or system as described herein.

For example, suitable systems and methods can be implemented comprising any one or more of: retrieving, from a market research data store, first market research survey data relating to rational and emotional drivers of consumer choice; computing a first plurality of coefficients of a first statistical model corresponding with the first market research survey data, where each coefficient represents a relative impact of an associated driver of consumer choice; retrieving, from the market research data store, second market research survey data relating to consumer response to marketing communications content that has been developed based upon leading drivers of consumer choice identified from the coefficients of the first statistical model; computing, using the first statistical model and second market research survey data, predicted changes in attributes of the target brand corresponding with the leading drivers of consumer choice resulting from the marketing communications content; computing, using the predicted changes in attributes of the target brand and current market share data, a predicted efficacy measure of the marketing communications content in changing market share of the target brand; computing a modified efficacy measure, based upon the predicted efficacy measure, a measure of communications media efficiency, a measure of consumer recognition of the marketing communications content, and a measure of consumer linkage of the marketing communications content to the target brand; and computing, using the modified efficacy measure along with provided financial factor data, one or more measures of commercial outcome from the marketing communications campaign.

Further aspects, advantages, and features of embodiments of the invention will be apparent to persons skilled in the relevant arts from the following description of various embodiments. It will be appreciated, however, that the invention is not limited to the embodiments described, which are provided in order to illustrate the principles of the invention as defined in the foregoing statements and in the appended claims, and to assist skilled persons in putting these principles into practical effect.

### BRIEF DESCRIPTION OF THE DRAWINGS

Embodiments of the invention will now be described with reference to the accompanying drawings, in which like reference numerals refer to like features, and wherein:

FIG. 1 is a block diagram illustrating an exemplary networked system including a marketing analytics server embodying the invention;

FIG. 2 is a process flow diagram illustrating the overall operation of an embodiment of the invention as illustrated in FIG. 1;

FIG. 3 is a schematic diagram showing an exemplary graphical presentation of results of modeling to establish lead behavioral indicators in accordance with an embodiment of the invention;

FIG. 4 is a schematic diagram showing a further exemplary graphical presentation of results of modeling to establish lead behavioral indicators in accordance with an embodiment of the invention;

FIG. 5 is a schematic diagram showing an exemplary graphical presentation of results of measurement of emotional responses of survey participants to two competing brands, in accordance with an embodiment of the invention;

FIG. 6 is a schematic diagram showing a further exemplary graphical presentation of results of measurement of emotional responses of survey participants to a client brands, before and after exposure to marketing communications content, in accordance with an embodiment of the invention;

FIG. 7 is a schematic diagram of an exemplary web-based graphical interface to a market share simulation module embodying the invention; and

FIG. 8 is a schematic diagram of an exemplary web-based graphical interface to an ROI modeling module embodying the invention.

### DETAILED DESCRIPTION

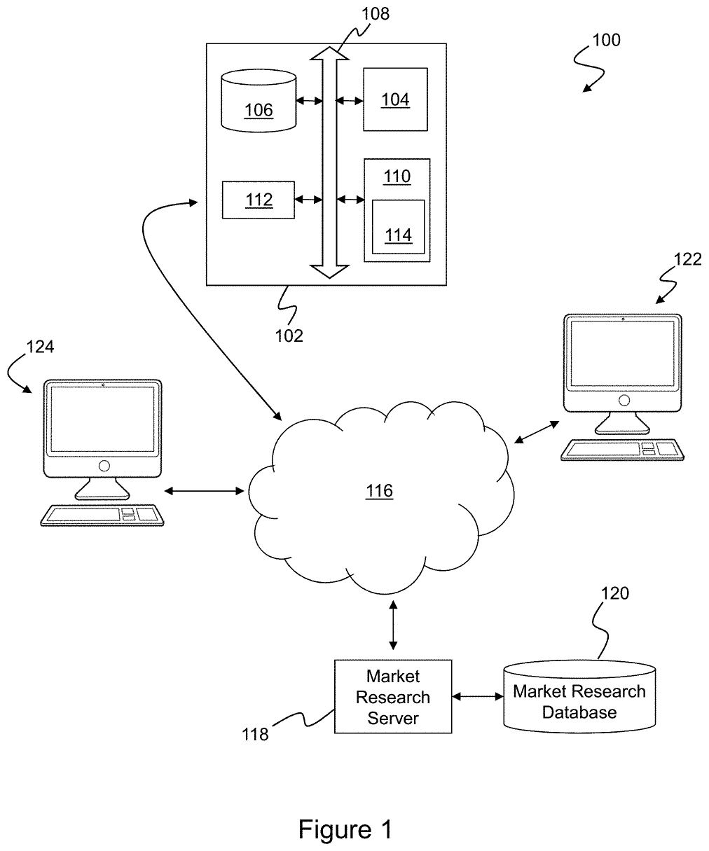

FIG. 1 is a block diagram illustrating an exemplary networked system 100 including a marketing analytics server 102 embodying the invention. In particular, the marketing analytics server 102 comprises a computer-implemented system embodying the invention, which is configured to perform modeling and analytics using market research and marketing activity data to predict the impact of communications on market share.

The marketing analytics server 102, as illustrated, comprises a processor 104. The processor 104 is operably associated with a non-volatile memory/storage device 106, e.g. via one or more data/address busses 108 as shown. The non-volatile storage 106 may be a hard disk drive, and/or may include a solid-state non-volatile memory, such as ROM, flash memory, solid-state drive (SSD), or the like. The processor 104 is also interfaced to volatile storage 110, such as RAM, which contains program instructions and transient data relating to the operation of the marketing analytics server 102.

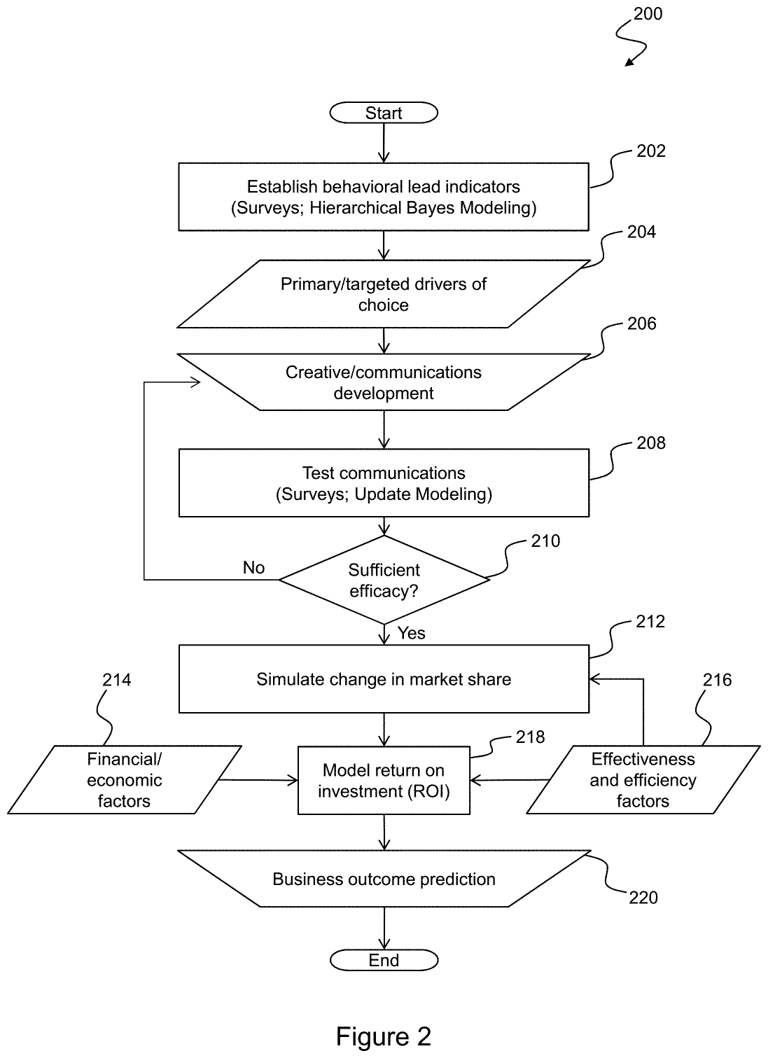

In a conventional configuration, the storage device 106 maintains program and data content required for operation of the marketing analytics server 102. For example, the storage device 106 may contain operating system programs and data, as well as other executable application software necessary for proper operation of the marketing analytics server 102. With particular relevance to implementation of the invention, the storage device 106 also contains specific program instructions which, when executed by the processor 104, cause the marketing analytics server 102 to perform operations relating to an embodiment of the present invention. These specific program instructions comprise one or more computer programs or program modules developed in accordance with principles and algorithms embodying the invention, such as are described in greater detail below, and with reference to FIGS. 2-8, in particular. In operation, instructions and data held on the storage device 106 are transferred to volatile memory 110 for execution on demand.

The processor 104 is also operably associated with a communications interface 112 in a conventional manner. The communications interface 112 facilitates access to a wide-area data communications network, such as the Internet 116.

In use, the volatile storage 110 contains a corresponding body 114 of program instructions transferred from the storage device 106 and configured to perform processing and other operations embodying features of the present invention. The program instructions 114 comprise a technical contribution to the art developed and configured specifically to implement an embodiment of the invention, over and above well-understood, routine, and conventional activity in the art of market modeling and analytics, as further described below, particularly with reference to FIGS. 2-8.

With regard to the preceding overview of the marketing analytics server 102, and other processing systems and devices described in this specification, terms such as ‘processor’, ‘computer’, and so forth, unless otherwise required by the context, should be understood as referring to a range of possible implementations of devices, apparatus and systems comprising a combination of hardware and software. This includes single-processor and multi-processor devices and apparatus, including portable devices, desktop computers, and various types of server systems, including cooperating hardware and software platforms that may be co-located or distributed. Physical processors may include general purpose CPUs, digital signal processors, graphics processing units (GPUs), and/or other hardware devices suitable for efficient execution of required programs and algorithms.

Computing systems may include conventional personal computer architectures, or other general-purpose hardware platforms. Software may include open-source and/or commercially available operating system software in combination with various application and service programs. Alternatively, computing or processing platforms may comprise custom hardware and/or software architectures. For enhanced scalability, computing and processing systems may comprise cloud computing platforms, enabling physical hardware resources to be allocated dynamically in response to service demands. While all of these variations fall within the scope of the present invention, for ease of explanation and understanding the exemplary embodiments are described herein with illustrative reference to single-processor general-purpose computing platforms, commonly available operating system platforms, and/or widely available consumer products, such as desktop PCs, notebook or laptop PCs, smartphones, tablet computers, and so forth.

In particular, the terms ‘processing unit’ and ‘module’ are used in this specification to refer to any suitable combination of hardware and software configured to perform a particular defined task. Such a processing unit or module may comprise executable code executing at a single location on a single processing device, or may comprise cooperating executable code modules executing in multiple locations and/or on multiple processing devices. For example, in some embodiments of the invention, modeling and analytics algorithms may be carried out entirely by code executing on a single system, such as the marketing analytics server 102, while in other embodiments corresponding processing may be performed in a distributed manner over a plurality of systems.

Software components, e.g. program instructions 114, embodying features of the invention may be developed using any suitable programming language, development environment, or combinations of languages and development environments, as will be familiar to persons skilled in the art of software engineering. For example, suitable software may be developed using the C programming language, the Java programming language, the C# programming language, the F# programming language, the Visual Basic (i.e. VB.NET) programming language, the C++ programming language, the Go programming language, the Python programming language, the R programming language, the SQL query language, and/or other languages suitable for implementation of applications, including web-based applications, comprising statistical modeling, data analysis, data storage and retrieval, and other algorithms. A particular embodiment of the invention may be implemented using the MICROSOFT® .NET framework for application development and execution, and MICROSOFT® SQL Server for data storage, retrieval and management. It will be appreciated by skilled persons, however, that embodiments of the invention involve the implementation of software structures and code that are not well-understood, routine, or conventional in the art of market modeling and analytics, and that while pre-existing languages, frameworks, platforms, development environments, and code libraries may assist implementation, they require specific configuration and extensive augmentation (i.e. additional code development) in order to realize various benefits and advantages of the invention and implement the specific structures, processing, computations, and algorithms described below, particularly with reference to FIGS. 2-8.

The foregoing examples of languages, environments, and code libraries are not intended to be limiting, and it will be appreciated that any convenient languages, libraries, and development systems may be employed, in accordance with system requirements. The descriptions, block diagrams, flowcharts, tables, and so forth, presented in this specification are provided, by way of example, to enable those skilled in the arts of software engineering, statistical modeling, and data analysis to understand and appreciate the features, nature, and scope of the invention, and to put one or more embodiments of the invention into effect by implementation of suitable software code using any suitable languages, frameworks, libraries and development systems in accordance with this disclosure without exercise of additional inventive ingenuity.

The program code embodied in any of the applications/modules described herein is capable of being individually or collectively distributed as a program product in a variety of different forms. In particular, the program code may be distributed using a computer readable storage medium having computer readable program instructions thereon for causing a processor to carry out aspects of the embodiments of the invention.

Computer readable storage media may include volatile and non-volatile, and removable and non-removable, tangible media implemented in any method or technology for storage of information, such as computer-readable instructions, data structures, program modules, or other data. Computer readable storage media may further include random access memory (RAM), read-only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. While a computer readable storage medium may not comprise transitory signals per se (e.g. radio waves or other propagating electromagnetic waves, electromagnetic waves propagating through a transmission media such as a waveguide, or electrical signals transmitted through a wire), computer readable program instructions may be downloaded via such transitory signals to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts, sequence diagrams, and/or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, and/or operations specified in the flowcharts, sequence diagrams, and/or block diagrams.

Returning to the discussion of FIG. 1, the networked system 100 includes a market research server 118, which is configured to manage and administer market research surveys, and to process, organize and store results of such surveys. A market research database 120 is operably associated with the market research server 118, and is used for storage of survey data, including questionnaires and associated survey results. In the networked system 100, the market research server 118 is configured to administer market research surveys via the Internet 116 to survey participants who access the server 118 using remote terminals, e.g. 122. The participant terminals may be conventional devices, such as desktop or laptop computers, tablets, smartphones, or other computing devices executing web browser software applications, and the market research server 118 may be configured to administer market research surveys via these devices via a web-based interface using conventional hypertext transfer protocol (HTTP), hypertext markup language (HTML), Javascript, and/or other web-based technologies.

Details of the operation of the market research server 118 are peripheral to the present invention. However, embodiments of the invention, e.g. the marketing analytics server 102, may retrieve, e.g. via the Internet 116, survey results stored in the database 120 for use in market modeling and analysis algorithms, such as the algorithms described below with reference to FIGS. 2-6.

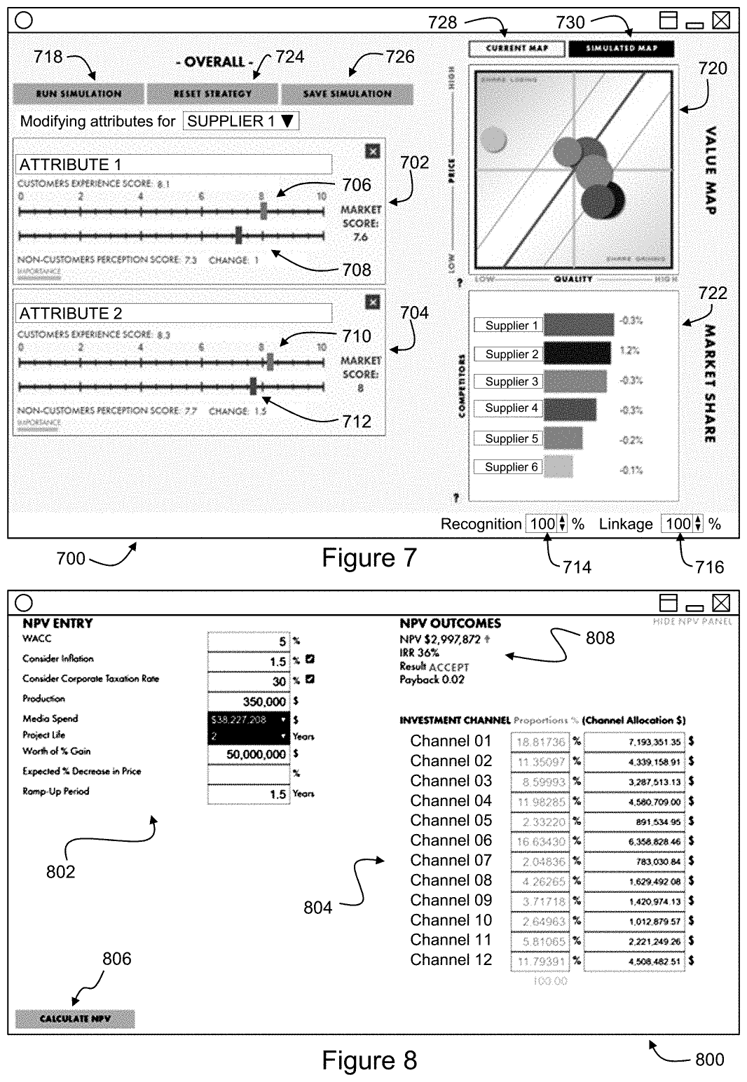

Also shown in FIG. 1 is an analytics client terminal 124 which may be operated by a user of the services provided by the marketing analytics server 102, such as an owner or employee of a business engaged in market analysis and modeling. According to particular embodiments of the invention, the marketing analytics server 102 implements an interface using web technologies, such as HTTP, HTML, and/or Javascript. This interface enables an operator of the terminal 124 to interact with the server 102 using a web browser application, in order to conduct modeling and analytics using market research and marketing activity data to predict the impact of communications on market share. An exemplary web-based interface is described below with reference to FIGS. 7 and 8.

The overall operation of an embodiment of the invention is illustrated by the flow diagram 200 shown in FIG. 2. According to this embodiment, the illustrated operations are conducted on behalf of a client business, which has an associated brand/reputation in a marketplace for the provision of particular goods or services. The market is also assumed to be served by one or more competitors to the client business. In the following discussion, the client business is identified as the ‘client brand’, while competitors are identified as ‘competing brands’. The processes making up the flow 200 are directed to designing and testing marketing communications (i.e. advertising) of the client brand, simulating the performance of the communications in the marketplace, and predicting a change in market share and revenue of the client brand expected to result from a corresponding marketing campaign. It is emphasized that this is fundamentally a series of technical processes, involving the deployment of sophisticated computer-implemented modeling and data analytics techniques, interacting with external processes including the administration of market surveys and the development of creative inputs (e.g. advertising media) to the proposed marketing campaign. Furthermore, these processes have substantial commercial utility, in providing a basis to predict the returns, e.g. in terms of enhanced profitability, from the proposed marketing campaign relative to the associated costs. As such, embodiments of the invention provide objective inputs to commercial decision-making that can significantly enhance efficiency, avoid ineffective or unwarranted expenditure, thereby providing benefits to the client brand and to consumers who will receive products, services, and marketing communications that are better targeted to their needs, interests and desires, at more competitive prices.

In a first process 202, a set of behavioral lead indicators is established. There are a number of elements to this process, as will be described in greater detail below with reference to FIGS. 2-5. Broadly speaking, however, the objective of the process 202 is to identify the most important drivers of customer choice, i.e. the attributes sought by consumers when selecting between the client brand and competing brands. These may comprise rational and emotional attributes. Rational attributes include price and quality, i.e. those attributes of products and services of which consumers are consciously aware when making a purchasing choice. Emotional attributes are the pre-cognitive emotional responses to brands and their communications. Rational and emotional attributes can be measured using surveys administered by the market research server 118, results of which can be stored in the database 120, and subsequently retrieved for further processing by program instructions 114 embodying the invention and executed at the marketing analytics server 102. The processing results in the identification of the lead indicators 204, i.e. the primary drivers of consumer choice that will be targeted by the client brand's marketing communications.

In a further process 206, external to the system 100, marketing creative is developed using the lead indicators as a guide. The objective of this external process is to devise concepts, messages and media that will move the lead indicators in a desired direction, such that consumer choice will shift towards the client brand and/or away from competing brands, in order to increase market share of the client brand. This will typically involve the engagement of advisers, such as advertising agencies, who have specialized expertise in this field.

In the subsequent process 208, the marketing creative is tested with consumers. Again, this can involve measurement of consumer responses to the concepts, messages and/or media developed in the creative process 206 via surveys administered by the market research server 118, results of which can be stored in the database 120, and subsequently retrieved for further processing by program instructions 114 embodying the invention and executed at the marketing analytics server 102. The processing results in identification of changes in the lead indicators 204, i.e. of the success with which the creative content has targeted the identified primary drivers of consumer choice. A decision 210 may then be made to move forward, or to conduct further creative development 206 in an effort to better target the primary drivers of choice.

The process 212 comprises market share simulation, implemented by program instructions 114 embodying the invention and executed at the marketing analytics server 102. The purpose of market share simulation is to predict efficacy of the proposed marketing campaign in terms of the change in market share of the client brand.

Output of the market share simulation process 212, along with additional inputs including financial inputs 214 and communications effectiveness and efficiency inputs 216 are employed by a subsequent process 218, which comprises return on investment (ROI) modeling implemented by program instructions 114 embodying the invention and executed at the marketing analytics server 102. The financial inputs 214 may include production costs and advertising spend over the campaign duration, as well as other economic factors such as inflation and taxation rates. With regard to the effectiveness and efficiency inputs 216, the effectiveness of campaign messaging can be defined in terms of two characteristics: recognition, i.e. the proportion of the target population who can recognize seeing the communication; and linkage, i.e. the proportion of the target population who associated the recognized message with the correct brand. Efficiency relates to the success of the campaign messaging in reaching the target population, which may be dependent upon the mix of different media (e.g. online, TV commercials, print, outdoor) employed in the campaign. Estimation of efficiency may be based on time-series analysis of past data linking advertising through different media to commercial outcomes, e.g. sales.

The ROI modeling process 218 generates a business outcome prediction 220. In particular, given knowledge of relevant financial factors 214, communications effectiveness and efficiency factors 216, and the predicted change in market share produced by the process of market share simulation 212, a predicted net outcome can be calculated which may be used to inform a business decision as to whether or not to proceed with the proposed marketing campaign.

The process 202 is performed by the marketing analytics server, which is configured, via a corresponding multivariate analysis module specifically implemented within the program instructions 114, to compute behavioral lead indicators for the products and/or services provided by the client and competitor brands. As has been noted, this process involves modeling and analysis based upon results of market surveys administered via the market research server 118, which may be retrieved from the database 120 for further processing by the marketing analytics server 102. In embodiments of the invention, two different types of survey may be administered, to gather data in relation to rational attributes, and emotional attributes, respectively. While the administration of surveys is peripheral to the present invention, the general nature of surveys conducted via the market research server 118 will now be described briefly, for the sake of clarity and understanding of the data retrieved by the marketing analytics server 102 for further processing.

Surveys for measuring rational attributes of client and competitor brands generally involve identifying suitable survey participants, e.g. those who are in the addressable market, such as those who currently have products/services or recently made a purchase choice with at least one of the brands being researched, using a series of initial qualifying questions. Selected participants are then presented with a series of further questions relating to rational attributes, such as quality and price, of the client brand and one or more competitor brands. Rational attributes and/or associated questions may be specific to the market, and suggested from additional information, such as qualitative research, client insights, and so forth. Survey questions typically request that participants rate characteristics of the client brand and/or one or more competitor brands on a numerical or categorical scale, resulting in responses that can be encoded numerically, from zero (meaning, e.g., lowest rating, ‘poor performance’, ‘strongly disagree’, or the like) to a maximum, such as 10 (meaning, e.g., highest rating, ‘excellent performance’, ‘strongly agree’, or the like).

Survey questions relating to quality may be broken down into subcategories, such as ‘performance’ and ‘reputation’. Performance ratings may be provided in response to questions regarding characteristics such as friendliness or service, efficiency of service, ease of use of a product, build quality of a product, and/or further characteristics specific to the market. For example, in the case of airline services, performance questions may relate to such characteristics and punctuality, comfort of seating, baggage allowance, convenience of flight schedules, and so forth. Participants may further be asked to rate the overall performance of the client brand and/or one or more competitor brands. Reputation ratings may be provided in response to questions regarding characteristics such as reliability, safety, longevity, and so forth. Participants may further be asked to rate the overall reputation of the client brand and/or one or more competitor brands.

Survey questions relating to price may comprise requests for participants to provide ratings of the client brand and/or one or more competitor brands in relation to various aspects of price-competitiveness. For example, in the case of airline services, price-competitiveness questions may relate to such characteristics as everyday pricing, discount/sale pricing, checked baggage fees, in-flight food and beverage pricing, booking change fees, and so forth. Participants may further be asked to rate the overall price-competitiveness of the client brand and/or one or more competitor brands.

Additionally, participants in a survey relating to rational attributes may be asked to evaluate overall quality and price-competitiveness in combination by providing a suitable consumer value assessment, such as a ‘value for money’ or ‘worth what is paid’ (WWP) rating.

Selected participants may also be presented with a survey to measure emotional attributes. A challenge in obtaining ratings of emotional responses to client and/or competitor brands is that the conventional ‘questionnaire’ approach, as described above in relation to measurement of rational attributes, inevitably involves conscious mediation, in order for the participants to read and comprehend the questions presented, and then to consider and provide their corresponding ratings. In order to address this challenge, embodiments of the invention employ a measurement system based upon animated scales designed in accordance with visual metaphors representing nine primary emotions—love, pride, contentment, happiness, anger, sadness, shame, anxiety and surprise—that have been developed through extensive studies and testing. The particular system used in exemplary embodiments of the invention is described in commonly assigned U.S. Pat. No. 8,939,903, issued on 27 Jan. 2015, and which is incorporated in its entirety herein by reference. In brief, this system for measurement of emotional attributes comprises first obtaining a baseline level of emotional response of each participant on each of the nine metaphorical scales. Participants are then presented with a sensory cue (e.g. a logo, TV advertisement, still image, online banner ad, outdoor advertising artwork, or other imagery) associated with the client brand or a competitor brand, and further emotional responses to the brand measured using the nine metaphorical scales. This may be repeated for one or more further brands (client and/or competitor). A resulting set of difference scores, representing the response with respect to each of the nine primary emotions, is thereby obtained for each presented brand.

Finally, each survey participant is asked to identify their ‘first choice’ (FC) of provider, subject to the assumption that there is no barrier to free selection of a preferred provider. Specifically, participants may be asked to rate characteristics of the client brand and/or one or more competitor brands on a numerical or categorical scale, resulting in responses that can be encoded numerically, from zero (meaning, e.g., lowest rating, or ‘extremely unlikely’) to a maximum, such as 10 (meaning, e.g., highest rating, or ‘extremely likely’).

The resulting survey data, stored to the market research database 120, comprises, for each participant, a set of numerical scores for each one of the rational attributes, and each one of the nine primary emotional attributes, in respect of a corresponding group of client and/or competitor brands. These survey scores reflect the participants' rating of the rational and emotional attributes, which constitute independent variables in the further processing and analysis performed by the marketing analytics server 102. Additionally, for each participant there is an FC selection, which comprises the dependent variable. The marketing analytics server is configured, via a corresponding multivariate analysis module within the program instructions 114, to estimate the relative impact of the independent variables (brand attributes) on the dependent variable (FC).

In various embodiments, the multivariate analysis module may be configured to implement different statistical modeling algorithms. For example, in some embodiments, structural equational modeling (SEM) may be employed. The SEM methodology estimates the unknown coefficients in a set of linear structural equations. Variables in the equation system are usually directly observed variables, such as participants' survey responses, and latent variables that are not observed, but relate to observed variables, such as the participants' underlying emotional responses. While SEM is a relatively complex form of analysis, it can readily be implemented as a software module.

In the presently disclosed embodiment, however, the multivariate analysis module is configured to implement hierarchical Bayesian modeling, to model the rational and emotional attributes together, using FC as the dependent attribute. Hierarchical Bayesian modeling has been found to provide improved flexibility and power over SEM, and to better integrate analysis of both rational and emotional drivers of behavior. Advantageously, the hierarchical Bayes modelling technique considers each respondent to be a unique sample within a population and applies information from other respondents to assist with modeling estimations, in order to obtain a different regression output for each respondent, as well as aggregate results for the overall product category. This methodology enables the rational and emotional drivers associated with consumer choice to be quantified and placed in a hierarchy. As such, hierarchical Bayesian modeling allows individuals to have different preferences, while maintaining an aggregate effect, and is able to utilize ‘within individual’ variation as well as ‘between individual’ variation to estimate parameters.

Specifically, the model may be represented by a set of linear equations having the following form:

FCᵢ_{ₖ}=γᵢ+[βᵢ^{e}xᵢ_{ₖ}^{e}+βᵢ^{r}xᵢ_{ₖ}^{r}+βᵢ^{p}xᵢ_{ₖ}^{p}]+[βᵢ^{E1}xᵢ_{ₖ}^{E1}+βᵢ^{E2}xᵢ_{ₖ}^{E2}+ . . . +βᵢ^{E9}xᵢ_{ₖ}^{E9}]+εᵢ_{ₖ}. [1]

In the above system of equations, the terms in the first set of square brackets represent the rational drivers of price (indicated by superscript e), reputation (superscript r), and performance (superscript p). The terms in the second set of square brackets represent the emotional drivers, with the nine primary emotions being represented by the superscript En (where n=1 . . . 9 corresponds with the emotions love, pride, contentment, happiness, anger, sadness, shame, anxiety and surprise). The subscript index i represents the distinct client and competitor brands. The subscript index k represents individual survey participants. The x's are survey response scores, as retrieved from the market research database 120. The β's are coefficients, to be determined through the hierarchical Bayesian modeling, representing the relative impact of each driver on FC for each brand. Finally, the Vs are bias terms and the c's are error terms, also determined through the hierarchical Bayesian modeling.

For the hierarchical Bayesian modeling, a Gaussian conjugate prior is used for the β coefficients, i.e.:

βᵢ˜ [symbol] (μ,Σ_{β}). [2]

The mean μ is also taken to be Gaussian-distributed, while the covariance matrix Σ_{β} is taken to follow an inverse-Wishart distribution, i.e.

μ˜ [symbol] (μ̅,A⁻¹); [3]

Σ_{β}˜W⁻¹(Ψ,ν). [4]

The multivariate analysis module is further configured to employ general linear regression models to specifically estimate the relative impact of the rational attributes onto FC. Furthermore, reputation attributes are modeled onto overall reputation, performance attributes are modeled onto overall performance, and price attributes are modelled onto overall price competitiveness—corresponding with the specific survey questions discussed above. Additional linear models are also implemented to estimate the relative impact of price competitiveness and quality on value, i.e. responses to the WWP rating survey question, where quality is taken to be dependent upon performance and reputation, and value/WWP is taken, in turn, to be dependent upon price competitiveness and quality. These linear models are represented by the following equations, in which ‘value’ is the dependent variable, and the parameters, independent variables, and error terms with subscripts R, P and E correspond with the reputation, performance and price sub-attributes, respectively, from the survey results:

reputationᵢ=β_{Ri}x_{Ri}+ε_{Ri}

performanceᵢ=β_{Pi}x_{Pi}+ε_{Pi}

priceᵢ=β_{Ei}x_{Ei}+ε_{Ei}

qualityᵢ=βᵣreputationᵢ+βₚperformanceᵢ+ε_{qi}

valueᵢ=βₑpriceᵢ+β_{q}qualityᵢ+εᵥᵢ. [5]

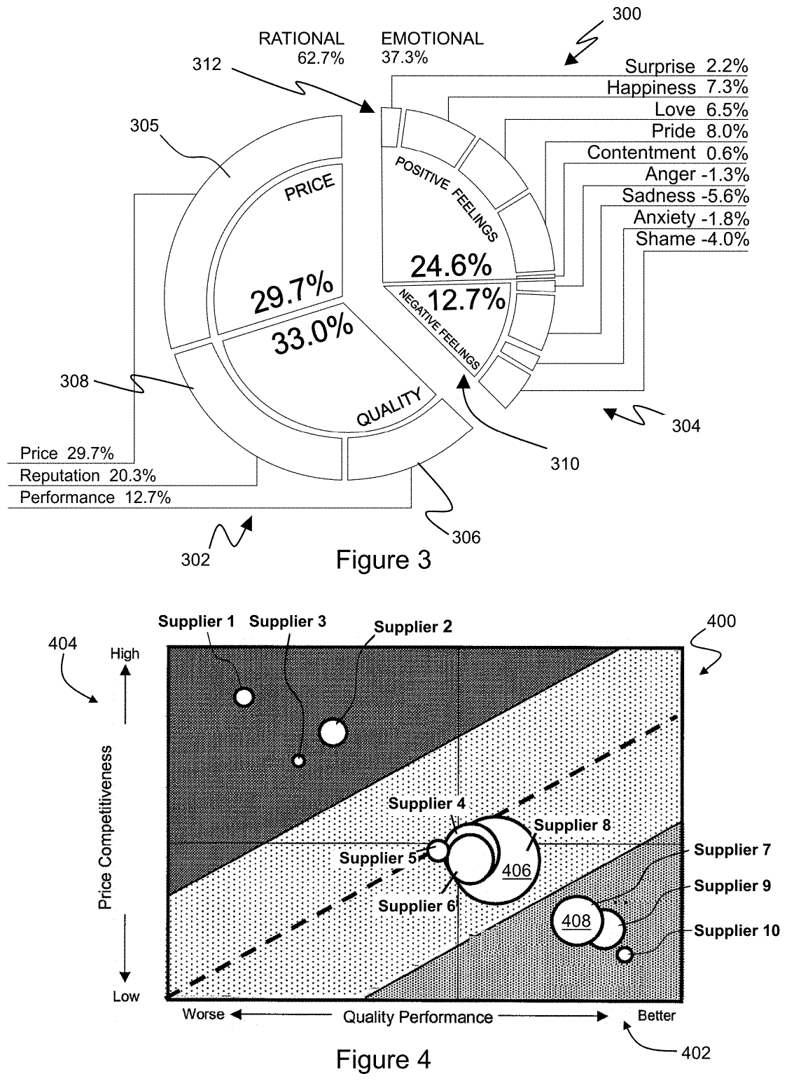

In an exemplary embodiment of the invention, results of the forgoing modeling are presented in a convenient graphical format to facilitate review and decision-making. An example of a graphical result presentation 300, which may be served to the client terminal 124 via a web-based interface, is illustrated in FIG. 3. In this example, the relative impact of rational drivers of choice, represented by the wedges 302, is 62.7%, while the relative impact of emotional drivers, represented by the wedge 304, is 37.3%. Within the hierarchy of rational drivers, quality and price 305 are both of similar importance, i.e. 33.0% versus 29.7%. Performance 306 contributes approximately one-third to survey participants' perception of quality, while reputation 308 contributes approximately two-thirds. These values are merely representative, and vary depending upon embodiment and application.

In the chart 300, the wedge 304 representing emotional drivers is broken down into the relative impact of positive and negative emotions or feelings within the central portion 310, and of the individual emotions around the outer circumference 312 (e.g., positive feelings including surprise, happiness, love, pride and contentment, and negative feelings including anger, sadness, anxiety, shame). The chart 300 therefore effectively shows the complete hierarchy of drivers of consumer choice at a glance.

Algorithm 1 is an exemplary pseudocode implementation of a method that can be embodied in the program instructions 114 executing on the marketing analytics server, based upon the modeling approach described above, to compute coefficients of the hierarchical Bayesian model and the linear regression model, and to present the modeling results in the graphical format 300 to facilitate identification of leading drivers of consumer choice from the model coefficients. As will be appreciated by persons skilled in the art of statistical modeling, implementations of fitting procedures for hierarchical Bayesian and linear regression models are available in statistical code libraries that can be incorporated into the program implemented by the instructions 114, and it is therefore assumed for the purposes of Algorithm 1 that a suitable code library is employed to provide these functions. However, specific computations and graphical output steps embodying the present invention are explicitly defined in Algorithm 1.

TABLE 1
Algorithm 1 for calculation of model
coefficients and presentation of graphical results (300)

| | |
|---|---|
| Input: | FCᵢ_{ₖ},xᵢ_{ₖ}^{D},Valueᵢ,x_{Ri},x_{Pi},x_{Ei}, individual and aggregate survey |
| | response scores with respect to drivers D ∈ {e, r, p, E1 ··· E9}, |
| | brands i, participants k |
| Output: | Graphical representation |
| | βᵢ^{D},β_{Ri},β_{Pi},β_{Ei},βᵣ,βₚ,βₑ,β_{q}, model coefficients |

```
[βᵢ^{D}] ← HB.fit(FCᵢ_{ₖ}; xᵢ_{ₖ}^{D})
[β_{Ri},β_{Pi},β_{Ei},βᵣ,βₚ,βₑ,β_{q}] ← Regression.fit(Valueᵢ; x_{Ri},x_{Pi},x_{Ei})
Δ ← 0
t ← 0
Loop foreach i:
    t ← t + (βᵢ^{e} + βᵢ^{r} + βᵢ^{p})
    Δ ← Δ + (βᵢ^{e} + βᵢ^{r} + βᵢ^{p})
    Loop foreach j in [1, 9]:
        Δ ← Δ + βᵢ^{Ej}
    End loop (j)
End loop (i)
$thoughts ( \% ) ← 100 \times \frac{t}{Δ}$
f ← 0
f₊ ← 0
fⱼ ← 0 foreach j in [1, 9]
Loop foreach i:
    Loop foreach j in [1, 9]:
        f ← f + βᵢ^{Ej}
        fⱼ ← fⱼ + βᵢ^{Ej}
        if (j^{th} emotion is positive) then:
            f₊ ← f₊ + βᵢ^{Ej}
    End loop (j)
End loop (i)
$feelings ( \% ) ← 100 \times \frac{f}{Δ}$
$positive\_feelings ( \% ) ← feelings ( \% ) \times \frac{{f}_{+}}{f}$
$negative\_feelings ( \% ) ← feelings ( \% ) \times ( 1 - \frac{{f}_{+}}{f} )$
Loop foreach j in [1, 9]:
    ${emotion}_{j} ( \% ) ← feelings ( \% ) \times \frac{{f}_{j}}{f}$
    $price ( \% ) ← thoughts ( \% ) \times \frac{{β}_{e}}{{β}_{e} + {β}_{q}}$
    $quality ( \% ) ← thoughts ( \% ) \times \frac{{β}_{q}}{{β}_{e} + {β}_{q}}$
    $performance ( \% ) ← quality ( \% ) \times \frac{{β}_{p}}{{β}_{p} + {β}_{r}}$
    $reputation ( \% ) ← quality ( \% ) \times \frac{{β}_{r}}{{β}_{p} + {β}_{r}}$
Draw inner wedges: price(%), quality(%), positive_feelings(%),
negative_feelings(%)
Draw outer segments: price(%), reputation(%), performance(%),
{|emotionⱼ| foreach j in [1, 9]}
```

An example of a further graphical representation 400 of modeling results in shown in FIG. 4. The representation 400 is a two-dimensional map having a quality performance dimension 402 and a price competitiveness dimension 404. The relative positions of brands evaluated in the survey are shown along these two dimensions. FIG. 4 shows a number of suppliers/brands 1-10 that compete in the marketplace, and which were subject to evaluation in the survey, one of which may be the client brand, e.g. 406 (supplier 8), and the others, e.g. 408 (supplier 7), may be competitor brands. Brands with high quality ratings and high price competitiveness (i.e. low price) are located on the bottom right hand corner of the map 400, while brands offering poor quality and high price are located on the top left corner of the map 400. Changes in consumer perception of quality and/or price competitiveness of different brands will result in changes in the relative locations of the brands on the map 400. The significance of this will be discussed further below, with reference to FIG. 7.

Algorithm 2 is an exemplary pseudocode implementation of a method that can be embodied in the program instructions 114 executing on the marketing analytics server to present the modeling results in the graphical format 400.

TABLE 2
Algorithm 2 for calculation and presentation of graphical results (400).

| | |
|---|---|
| Input: | x_{Ri}, x_{Pi}, x_{Ei}, survey response scores with respect to reputation, performance, and price |
| | sub-attributes for brands i |
| | β_{Ri}, β_{Pi}, β_{Ei}, βᵣ, βₚ, βₑ, β_{q}, coefficients obtained from prior regression (see Algorithm 1) |
| | Mᵢ, measure of brand market share, e.g. customer penetration |
| | g, measure of relative impact relationship between price and quality |
| Output: | Graphical representation |

Loop foreach i:

Qᵢ ← βᵣβ_{Ri}x_{Ri} + βₚβ_{Pi}x_{Pi}
Eᵢ ← β_{Ei} x_{Ei}

End loop (i)
Draw chart: x-axis ← ‘Quality’ (0-10); y-axis ← ‘Price’ (0-10); dashed impact reference, gradient
g
Loop foreach i:

Draw circle: center (Qᵢ, Eᵢ); radius Mᵢ; label brandᵢ

End loop (i)

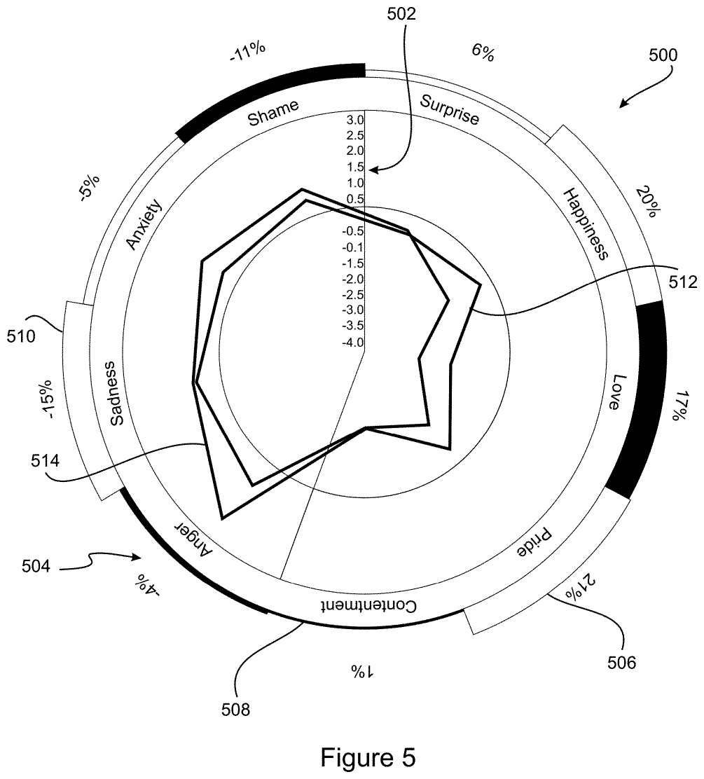

Yet another graphical representation of modeling results in shown in FIG. 5. A chart 500 comprises a visual representation of the results of measurement of the emotional responses of survey participants to two different brands, e.g. a client brand and a competitor brand. The chart 500 has a scale 502 ranging, in this particular example, from −4.0 to +3.0, representing changes in emotional state between the initial baseline measurement and following exposure to sensory cues corresponding with each brand. Around the outer circumference of the chart 500 is a ring 504 of bars representing the relative impacts of each one of the nine measured emotions on influencing consumer choice in relation to the goods and/or services offered by the competing brands (e.g., surprise, happiness, love, pride, contentment, anger, sadness, anxiety and shame). These impacts are represented as percentages, and corresponding thicknesses of the respective bars. Thus, for example, the bar 506 represents the relative impact of pride, being 21%, the bar 508 represents the relative impact of contentment, being 1%, and the bar 510 represents the relative impact of sadness, being −15%.

The relative impacts 506, 508, 510 may be interpreted as follows. In this example, the positive emotion ‘pride’ (506) has a relatively high positive impact of 21%. This means that pride is a relatively strong driver of consumer choice in relation to goods/services provided by the competing brands. Accordingly, marketing communications that tend to increase a sense of pride will have a relatively strong impact on consumer choice. By contrast, the emotion ‘contentment’ (508) has a low relative impact of only 1%. Accordingly, communications that elicit feelings of contentment will have relatively minimal impact on consumer choice. Considering the emotion ‘sadness’ (510), this is a negative emotion and has a negative relative impact of −15%. This indicates that communications resulting in a reduction of levels of sadness are likely to have a relatively strong positive impact on consumer choice.

As will be appreciated, the use of graphical bars 506, 508, 510 around the circumference 504 of the chart 500, in addition to the actual percentage values of the relative impacts, enables the emotions having the strongest relative impacts to be readily identified at a glance.

Aggregate responses of survey participants to the two brands are represented by the ‘spider web traces’ 512, 514. The results indicate that participants expressed generally greater negative emotional responses, and particularly anger, to the brand represented by the trace 514 than to the brand represented by the trace 512. Conversely, participants tended to express greater positive emotional responses, such as pride and happiness, to the brand represented by the trace 512 than to the brand represented by the trace 514.

Algorithm 3 is an exemplary pseudocode implementation of a method that can be embodied in the program instructions 114 executing on the marketing analytics server to present the modeling results in the graphical format 500.

TABLE 3
Algorithm 3 for calculation and presentation of graphical results (500).

| | |
|---|---|
| Input: | xᵢ_{ₖ}^{Ej}, baseline response scores with respect to emotional drivers j, |
| | brands i, participants k |
| | \hat{x}ᵢ_{ₖ}^{Ej}, post-exposure response scores with respect to emotional |
| | drivers j, brands i, participants k |
| | β^{Ej}, coefficients for emotional drivers j obtained from prior |
| | modeling |
| Output: | Graphical representation |

```
B ← Sumⱼ(β^{Ej})
Loop foreach j in [1, 9]:
    ${impact}_{j} ( \% ) ← 100 \times \vert \frac{{β}^{Ej}}{B} \vert$
    Draw outer bar: impactⱼ(%)
End loop (j)
Loop foreach i:
    Loop foreach j in [1, 9]:
        rᵢⱼ ← Averageₖ(\hat{x}ᵢ_{ₖ}^{Ej}) − Averageₖ(xᵢ_{ₖ}^{Ej})
    End loop (j)
    Plot: trace connecting radial points (j, rᵢⱼ) ∀j ∈ {1 ··· 9}
End loop (i)
```

Charts such as those shown in FIGS. 3-5, generated by software modules implemented within the instructions 114 executing on the marketing analytics server 102, and displayed to an analytics client via the terminal 124, can be used to guide the development of marketing creative in the external process 206.

Once suitable marketing creative has been developed, it is tested in the process 208. The process 208 is performed by the marketing analytics server, which is configured, via a corresponding test response analysis module within the program instructions 114, to compute the impact of the marketing creative on the consumer drivers of behavior. Testing may use the same survey methodology and statistical algorithms employed in the initial modeling process 202, however the surveys administered via the market research server 118 may be focused on the specific lead indicators (i.e. most influential) drivers identified in the earlier modeling. This approach can be used to reduce the number of survey questions by ignoring those drivers that have been found to have relatively minimal impact on consumer choice.

In particular, survey participants in the process 208 may be exposed to proposed marketing communications content, prior to administration by the market research server 118 of a survey seeking responses in relation to various rational and emotional drivers of behavior. The results can then be input to a market test response analysis module within the program instructions 114 of the marketing analytics server 102, to compute results using the hierarchical Bayesian model described above. These results, which represent predicted changes in attributes of the target brand resulting from the marketing communications content, may be visualized in a similar manner to the visualization described above with reference to FIGS. 3-5. The resulting rational and emotional profiles for the client brand can then be compared with those generated in the initial study conducted via the process 202.

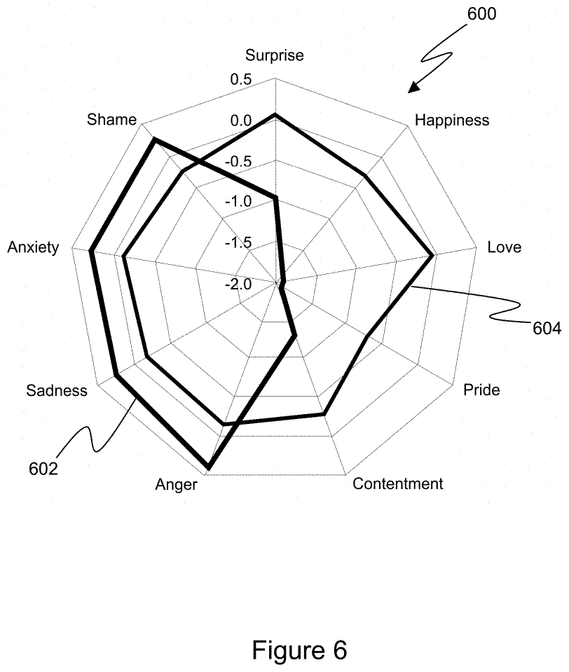

By way of example, an exemplary visual comparison of emotional attributes is illustrated in FIG. 6. The chart 600 shows aggregate responses, in the form of further spider web traces, of survey participants in the initial study 602 and following exposure to the proposed marketing communications content 604. The traces 602,604 are calculated and drawn in the same manner as those in the chart 500, e.g. in accordance with Algorithm 3, except that the comparison is now between participants' original response to the client brand, and the response of participants exposed to the proposed marketing communications content, rather than between competing brands. The results indicate that the communications content had a generally positive effect on participants' emotional responses to the brand, reducing negative emotional responses and increasing positive emotional responses. It should further be appreciated that such changes are of particular significance where they occur in relation to drivers having higher impact, i.e. those corresponding with the leading drivers of consumer choice identified in the initial modeling process 202.

The output of the test process 208 is thus an objective measure of the impact of the communications in driving a change in brand attributes, which can be used as the basis for a decision 210 on how to proceed. Preferably, this change comprises an improvement in the lead indicators of consumer choice, however if this is not the case, or the improvement is not considered sufficient, the client can elect to iterate the communications development process 206 in an effort to devise more effective communications.

At this point, the change in rational and emotional attributes elicited by the proposed marketing communications, i.e. the efficacy of the communications, may be regarded as the potential position assuming 100% effectiveness of communications, and 100% efficiency of media. In other words, the modeling to this stage assumes ‘perfect information’, meaning that the communications reach the entire target market for the relevant goods and/or services provided by the client brand, that 100% recognition is achieved (i.e. every member of the target population can remembers seeing the communication), and that 100% linkage is achieved (i.e. every member of the target population associates the recognized message with the client brand).

The process 212 of market share simulation is performed by the marketing analytics server, which is configured, via a corresponding market share simulation module within the program instructions 114, to simulate estimated changes in market share of the client brand based upon the changes in rational and emotional attributes elicited by the proposed marketing communications output from the test process 208. The market share simulation module may employ a customer value analysis (CVA) module to facilitate estimation of changes in market share. Algorithms employing CVA to estimate changes in market share based on changes in brand attributes, and assuming perfect information, are described in commonly assigned US patent application publication no. 2008/0010108 published on 10 Jan. 2008, which is incorporated in its entirety herein by reference. In brief, these algorithms perform a linear regression analysis considering WWP as the independent variable (recalling that survey participants may be requested to evaluate WWP as part of the initial modeling process 202). However, embodiments of the present invention may alternatively employ a consumer choice analysis module that differs from the CVA module in that FC is used as the dependent variable, in place of WWP.

More particularly, a method of predicting changes in market share assuming perfect information, and which forms the basis in embodiments of the invention for market share simulation assuming perfect information, comprises retrieving market research data suitable for the consumer choice analysis, including survey responses stored in the market research database 120 and current market share data. The analysis is then performed to determine coefficients of a linear regression model having brand attributes as the independent variables, and FC as the dependent variable. The coefficients thereby represent the relative importance of each brand attribute to FC. The changes in brand attributes elicited by the proposed marketing communications output from the test process 208 can then be applied to the resulting regression model to determine a corresponding predicted change in the FC value. From this, a postulated market value is calculated as a function of the calculated FC value, to determine a corresponding predicted change in market share.

The output of the market share simulation module is further processed by an ROI modeling module within the program instructions 114 of the marketing analytics server. Additional financial inputs 214 to the ROI modeling module may include: weighted average cost of capital (WACC); operating environment factors such inflation and taxation rates; the investment associated with achieving the increase in market share, i.e. anticipated communications production costs and advertising spend; campaign/project duration and ramp-up period; and cash inflows, i.e. expected increase in revenues associates with a unit increase in market share. Using this data, the ROI modeling module is configured to compute a net present value (NPV) of the proposed marketing campaign, defined as the sum of the present values of the annual cash flows minus the initial investment. In particular, the market share simulation module is configured to compute three outputs that can be used to assess the financial viability of the project. The first output is the NPV, which is the increase in the value in the business today after considering all relevant cash flows, the timing of the cash flows and the risk in generating the cash flows. The NPV must be positive for the project to be financially viable. The second output is the internal rate of return (IRR), which can be compared with the WACC, or some other required threshold rate. If the IRR is greater than the required rate of return, the investment is worthwhile. The third output is a payback period, which is the time taken for the cumulative incremental benefits to match the initial investment.

As has been noted, the above-described method of predicting changes in market share and modeling ROI assumes perfect information. This may result in over-estimation of the changes, since the assumed behaviors will not be exhibited by consumers who do not receive the marketing communications (i.e. reduction due to imperfect efficiency of the media), who do not remember receiving the communications (i.e. reduction due to imperfect recognition), and/or who do not associate the received message with the client brand (i.e. reduction due to imperfect linkage). In order to account for these factors, embodiments of the invention incorporate effectiveness and efficiency inputs 216 to the market share simulation and ROI modeling modules. The additional effectiveness inputs may be incorporated into the market share simulation process 212, and combined with the additional efficiency input when computing the return on investment (ROI) of the project, i.e. the NPV, IRR and payback period. In particular, if the efficacy assuming perfect information is denoted as η, recognition as γᵣ, linkage as γₗ, and media efficiency as μₑ, then a modified efficacy can be computed by the ROI modeling module that is defined by:

η′=(η×γᵣ×γₗ)×μₑ. [6]

The ROI modeling module is then configured to use the modified efficacy value η′ in place of the efficacy output of the test process 208. Suitable values for the recognition, γᵣ, linkage, γₗ, and media efficiency, μₑ, parameters may be estimated from past experience, and/or from data gathered from surveys administered by the market research server 118 designed to test recognition and linkage achieved by proposed communications. In some embodiments, media efficiency, μₑ, is estimated using media mix modeling, which comprises time-series analysis of past data to determine the relative efficiency of different media (e.g. online, TV commercials, outdoor advertising, and so forth) in delivering desired commercial outcomes, such as sales. Media mix modeling may be performed externally to the marketing analytics server, and the results retrieved from a remote source (not shown in the diagrams) via a local communications network, or via the Internet 116. Additionally, or alternatively, media mix modeling results may be stored on the local storage device 106.

In embodiments of the invention, the marketing analytics server 102 may be further configured, via program instructions 114, to enable a client user at the analytics client terminal to interact with the market share simulation module and the ROI modeling module through a web-based interface.

FIG. 7 is a schematic diagram of an exemplary web-based graphical interface 700 (e.g., a graphical user interface or GUI running on a user terminal or user device), which communicates with the market share simulation module implemented by an embodiment of a marketing analytics server 102 and processor 104. In this example, the user of the analytics client terminal or device can experiment with the effect of changing consumer responses to brand attributes; e.g., via standard web browser software or other graphical interface executing on a user terminal or user device. In this exemplary interface 700, two attributes (e.g., any rational or emotional attributes 1 and 2, as described herein) are shown having corresponding interactive regions 702, 704. Each interactive region includes sliders, corresponding to aggregate responses of consumers to the respective attributes. In each case, an upper slider 706, 710 is associated with responses of customers of the client brand (i.e. consumer/customer experience score), while a lower slider 708, 712 is associated with responses of non-customers of the client brand (i.e. consumer/non-customer perception score). The sliders 706, 708, 710, 712 may default to values determined from the testing process 208. Adjusting the sliders to alternative values enables the user of the analytics client terminal to test the impact of achieving lesser or greater changes in brand attributes, which may inform business decision-making as to whether further development or refinement of the marketing creative may be worthwhile, i.e. by revising the development and test processes 206, 208.

The exemplary interface 700 also includes numerical entry fields 714, 716 enabling the user to set values for recognition, γᵣ, and linkage, γₗ, parameters respectively. In the example shown, these values default to 100%, i.e. corresponding with the conventional assumption of perfect information. However, as noted above, more realistic values for these parameters may be estimated from past experience, and/or from data gathered from surveys administered by the market research server 118 designed to test recognition and linkage achieved by proposed communications. Where the recognition and linkage parameters are available from external sources, the default values of the numerical entry fields 714, 716 may be set based upon those sources, however the user may still be enabled to adjust the parameters in order to simulate the effects of variations in recognition and/or linkage.

After adjusting one or more of the sliders 706, 708, 710, 712, and/or the recognition and linkage values 714, 716, the user may select a ‘run simulation’ button 718, which causes the market share simulation module to re-run its algorithms to update its market share predictions. The interface 700 includes a quality/price map 720 (c.f. the map 400 in FIG. 4) and a bar chart 722 showing the simulated change in market share for the client brand and competitor brand(s).

After executing the simulation, the user may elect to reset the sliders to the default values determined from the testing process 208 using the button 724 or save the current simulation settings and results using the button 726. Two further buttons 728, 730 enable the user to switch between visualization of maps 720 resulting from the simulation, and representing the current position determined in the initial modeling process 202.

Algorithm 4 is an exemplary pseudocode implementation of a method that can be embodied in the program instructions 114 executing on the marketing analytics server to implement the calculations and display updates associated with the interface 700. In particular, Algorithm 4 may be executed when the user selects the ‘run simulation’ button 718. As noted above, methods of estimating changes in market share based on changes in brand attributes, assuming perfect information, are described in commonly assigned US patent application publication no. 2008/0010108 published on 10 Jan. 2008, to which the reader is referred for implementation details of the MarketSimulation function employed in embodiments of the present invention. In general, recognition, linkage and media efficiency parameters may be determined and/or supplied for each individual brand, although these may commonly be of interest primarily in relation to the client brand rather than competitor brands, e.g. as indicated by the numerical entry fields 714, 716 of the exemplary interface 700. Algorithm 4 provides for the general case in which these parameters may be provided for all brands, with defaults of 1.0 (i.e. 100%) when not supplied.

TABLE 4
Algorithm 4 for mark simulation and update of graphical results (720, 722).

| | |
|---|---|
| Input: | x_{Ri}, x_{Pi}, x_{Ei}, baseline response scores with respect to reputation, performance, and |
| | price |
| | x_{Ri}′, x_{Pi}′, x_{Ei}′, updated response scores with respect to reputation, performance, and |
| | price sub-attributes for brands i, e.g. from post-exposure survey or input via |
| | interface (700) |
| | β_{Ri}, β_{Pi}, β_{Ei}, βᵣ, β_{p,} βₑ, β_{q}, coefficients obtained from prior regression (see Algorithm 1) |
| | Mᵢ, baseline measure of brand market share, e.g. customer penetration |
| | γᵣⁱ, γₗⁱ, recognition and linkage factors per brand i, e.g. input via interface (700); default |
| | value 1.0 if not supplied |
| | μₑⁱ, media efficiency per brand i, e.g. obtained from media mix modeling; default value |
| | 1.0 if not supplied |
| Output: | Graphical representation |
| | ηᵣΔMᵢ, changes in brand market share with imperfect information |

ΔMᵢ ← MarketSimulation(x_{Ri}′, x_{Pi}′, x_{Ei}′, Mᵢ)
Loop foreach i:

ηᵣⁱ ← γᵣⁱ × γₗⁱ × μₑⁱ
Qᵢ ← βᵣβ_{Ri}x_{Ri}′ + βₚβ_{Pi}x_{Pi}′
Eᵢ ← β_{Ei}x_{Ei}′
M′ᵢ ← Mᵢ + ηᵣⁱΔMᵢ
End loop (i)

Loop foreach i:

Redraw circle: center (Qᵢ, Eᵢ); radius M′ᵢ; label brandᵢ
Draw bar: length M′ᵢ, label (%) 100 × ηᵣⁱΔMᵢ

End loop (i)

FIG. 8 is a schematic diagram of an exemplary web-based graphical interface 800 (e.g., a graphical user interface or GUI), which communicates with the ROI modeling module implemented by an embodiment of the marketing analytics server 102 and processor 104. In this example, the user of the analytics client terminal or interface 800, via standard web browser software or other graphical interface 800 operating on a user terminal or user device, can review and/or adjust financial inputs 214 via text boxes 802, and communications efficiency inputs 216 via text boxes 804.

In the example shown, communications efficiency is determined using media mix modeling, where the user can specify the share of media spend allocated to each one of a number of channels. Representative Net Present Value (NPV) entry fields include weighted average cost of capital (WACC), inflation rate, taxation rates (e.g. corporate taxation rate), investment amounts associated with achieving the increase in market share (e.g. production), media spend, campaign duration (project life), worth of increase in market share gain (e.g., in percent), expected decrease in price (e.g., in percent), and campaign ramp-up period. Representative output (or predicted outcomes) include NPV (e.g., in US $), internal rate of return (IRR); payback period, and a result or recommendation (e.g., to accept the proposed input parameters, or decline or reject the parameters in favor of an alternative campaign). Representative investment channels can include, but are not limited to, online services and search engines like Google and Bing, place-based media and brand or credit out-of-home or OOH services, retail airways, video and display media channels, vacation exchange and rental sites, paid search services, social and digital media branding services, and television-based media and credit services (e.g., credit TV).

After setting the input values 802, 804, the user may click on the button 806 to instruct the ROI modeling module to compute ROI in the form of NPV outcomes comprising NPV, IRR, and payback period, which are displayed in the region 80 of the interface 800. The ROI modeling module may also display an overall recommendation of whether to accept or reject the campaign based on these results.

More specifically, any suitable financial factors and measures of commercial outcome can be represented on a graphical interface 700 or 800, for example in the form of a browser on a user device or terminal that is in communication with the marketing server 102 and processor 104. The communications media efficiency value μₑ can be displayed for a given set of media allocations, and then updated in response to a change in the media spend for one or more media channels. The change can easily be specified by the user, via the graphical interface, with updates in near-real time.

Consumer choice can also be represented on the graphical interface, for example a consumer first choice (FC) represented as a dependent variable of the hierarchical Bayesian model, and derived from the first market research survey data. Consumer value assessments can also be displayed, for example as a dependent variable of a linear regression model, such as a consumer worth-what-is-paid (WWP) response derived from the first market research survey data. The financial factor data can then be updated in response to user input, also via the graphical interface.

Specific financial factor represented can include weighted average cost of capital (WACC), inflation rate, taxation rates, an investment amount associated with achieving the increase in market share, campaign duration, campaign ramp-up period, and a measure of expected increase in revenue associates with an increase in market share. Specific measures of commercial outcome can also be displayed, for example net present value (NPV), internal rate of return (IRR), and payback period for the marketing communications campaign. The graphical interface can further be adapted for the user to specify a share of media spend allocated to one or more media channels, and to update one or more of the NPV, IRR, and payback period in response to the specified share, or to provide a recommendation to accept or reject the marketing communications campaign based on the results.

From the foregoing, it can be seen that the present embodiments provide a computer system implementing algorithms that analyze initial survey data to model consumer preferences and identify behavioral lead indicators among rational and emotional attributes of competing brands, analyze subsequent survey data associated with proposed marketing communications to identify changes in the lead indicators elicited by the communications, perform simulations to predict corresponding changes in market share, and model the impact of the predicted changes in market share to determine a predicted ROI for a marketing campaign. Embodiments of the invention incorporate effectiveness and efficiency inputs, eliminating a conventional assumption of ‘perfect information’ which fails to account for imperfect efficiency of media channels, imperfect recognition by consumers of marketing messages, and imperfect linkage by consumers of the messages to the corresponding brand. Algorithms implemented in embodiments of the invention are based on advances in the technical disciplines of marketing science, data science, modeling and analytics, to measure the performance of marketing communications, and predict the corresponding impact on market share and ROI of a proposed marketing campaign. Client brands are thereby able to make more informed decisions in relation to their marketing investments. Improved decision-making may significantly enhance efficiency, avoid ineffective or unwarranted expenditure, and thus provide benefits to the client brand and to consumers who will receive products, services, and marketing communications that are better targeted to their needs, interests and desires, at more competitive prices.

### Examples

In various examples and embodiments, a computer-implemented method of predicting changes in market share is responsive to a marketing communications campaign associated with a target brand. The method includes one or more steps, including but not limited to retrieving, from a market research data store, first market research survey data relating to rational and emotional drivers of consumer choice, and computing a first plurality of coefficients of a first statistical model corresponding with the first market research survey data; e.g., where each coefficient represents a relative impact of an associated driver of consumer choice.

The method can also include one or more of retrieving, from the market research data store, second market research survey data relating to consumer response to marketing communications content that has been developed based upon leading drivers of consumer choice identified from the coefficients of the first statistical model, computing, using the first statistical model and second market research survey data, predicted changes in attributes of the target brand corresponding with the leading drivers of consumer choice resulting from the marketing communications content, computing, using the predicted changes in attributes of the target brand and current market share data, a predicted efficacy measure of the marketing communications content in changing market share of the target brand, computing a modified efficacy measure, based upon the predicted efficacy measure, a measure of communications media efficiency, a measure of consumer recognition of the marketing communications content, and a measure of consumer linkage of the marketing communications content to the target brand, computing, using the modified efficacy measure along with provided financial factor data, one or more measures of commercial outcome from the marketing communications campaign, and representing the one or more measures of commercial outcome on a graphical interface in communication with the processor.

In some embodiments, the predicted efficacy measure is a numerical value η, the measure of consumer recognition is a numerical value γᵣ, the measure of consumer linkage of the marketing communications content to the target brand is a numerical value γᵢ, the measure of communications media efficiency is a numerical value μₑ, and the modified efficacy is a numerical value η′ which is computed according to the formula η′=(η×γᵣ×γₗ)×μₑ. The communications media efficiency value μₑ can be computed using a media mix modeling algorithm, for example by representing the media efficiency value on the graphical interface, and/or updating the media efficiency value responsive to a change in media spend allocated to one or more media channels by the marketing campaign; e.g., where the change is specified by the user via the graphical interface.

The first statistical model can comprise a hierarchical Bayesian model. For example, the consumer choice can be represented as a dependent variable of the hierarchical Bayesian model, and comprises a consumer first choice (FC) selection derived from the first market research survey data and represented on the graphical interface.

The method can comprise one or more of retrieving, from the market research data store, consumer value assessment data, and computing a second plurality of coefficients of a second statistical model, where each coefficient represents a relative impact of an associated attribute of the target brand on a consumer value assessment, and representing the relative impact and associated attribute on the graphical interface. For example, the second statistical model can comprise a linear regression model, and the consumer value assessment can be represented as a dependent variable of the linear regression model, comprising a consumer worth-what-is-paid (WWP) response derived from the first market research survey data, and represented on the graphical interface.

The method can be practiced where the provided financial factor data comprise one or more of weighted average cost of capital (WACC), inflation rate, taxation rates, an investment amount associated with achieving the increase in market share, campaign duration, campaign ramp-up period, and a measure of expected increase in revenues associates with an increase in market share. For example, the method can also include representing the financial factor data on the graphical interface, and/or updating the financial factor data responsive to user input via the graphical interface.

The method can also be practiced where the measures of commercial outcome from the marketing communications campaign comprise one or more of net present value (NPV), internal rate of return (IRR), and payback period for the marketing communications campaign, for example where one or more of the NPV, IRR, or payback period is represented on the graphical interface, where the graphical interface is adapted for the user to specify a share of media spend allocated to one or more media channels by the marketing communications campaign, and to update one or more of the NPV, IRR, and payback period responsive thereto, and/or where the graphical interface provides a recommendation to accept or reject the marketing communications campaign based on one or more of the NPV, IRR, or payback period.

A computing system for predicting changes in market share can also be responsive to a marketing communications campaign associated with a target brand. For example the system can comprise any one or more of a processor in communication with a graphical interface, at least one memory device accessible by the processor, and at least one market research data store accessible by the processor. In some embodiments, the memory device contains a non-transitory, computer-readable data storage medium having program instructions stored thereon which, when executed by the processor, cause the computing system to implement a marketing analytics system, as described herein.

Depending on application, the marketing analytics system can include one or more of a multivariate statistical analysis module configured to retrieve, from the market research data store, first market research survey data relating to rational and emotional drivers of consumer choice, and to compute a corresponding first plurality of coefficients of a first statistical model, e.g., where each coefficient represents a relative impact of an associated driver of consumer choice. The system can also include a test response analysis module configured to retrieve, from the market research data store, second market research survey data relating to consumer response to marketing communications content that has been developed based upon leading drivers of consumer choice identified from the coefficients of the first statistical model, and to use the first statistical model and second market research survey data to compute predicted changes in attributes of the target brand corresponding with the leading drivers of consumer choice resulting from the marketing communications content.

A market share simulation module can be configured to compute, using the predicted changes in attributes of the target brand and current market share data, a predicted efficacy measure of the marketing communications content in changing market share of the target brand. A return on investment (ROI) modeling module can be configured to compute a modified efficacy measure, based upon the predicted efficacy measure, a measure of communications media efficiency, a measure of consumer recognition of the marketing communications content, and a measure of consumer linkage of the marketing communications content to the target brand, and to use the modified efficacy measure along with provided financial factor data to compute one or more measures of commercial outcome from the marketing communications campaign. A client interface module can be configured for a user to interact with the market share simulation module and the ROI modeling module via the graphical interface; e.g., where the one or more measures of commercial outcome are represented.

The system of can be implemented where the predicted efficacy measure is a numerical value η, the measure of consumer recognition is a numerical value γᵣ, the measure of consumer linkage of the marketing communications content to the target brand is a numerical value γₗ, the measure of communications media efficiency is a numerical value μₑ, and the modified efficacy is a numerical value η′, which is computed according to the formula η′=(η×γᵣ×γₗ)×μₑ. The communications media efficiency value μₑ can be computed using a media mix modeling algorithm, and represented on the graphical interface.

The system can be implemented where the first statistical model comprises a hierarchical Bayesian model. For example, the consumer choice can be represented as a dependent variable of the hierarchical Bayesian model, and comprises a consumer first choice (FC) selection derived from the first market research survey data and represented on the graphical interface.

The system can also be implemented where the provided financial factor data comprise one or more of weighted average cost of capital (WACC), inflation rate, taxation rates, an investment amount associated with achieving the increase in market share, campaign duration, campaign ramp-up period, and a measure of expected increase in revenues associates with an increase in market share. The financial factor data can be represented on the graphical interface, and/or updated responsive to user input via the graphical interface.

In some examples, the measures of commercial outcome from the marketing communications campaign comprise one or more of net present value (NPV), internal rate of return (IRR), and payback period. The ROI modeling module can be adapted to provide a recommendation to accept or reject the marketing communications campaign on the graphical interface, based on one or more of the NPV, IRR, or payback period, the graphical interface can be adapted for the user to adjust one or more financial inputs to the marketing communications campaign, for example where the user specifies a share of media spend allocated to one or more media channels by the marketing communications campaign, and/or the ROI modeling module can be adapted to update one or more of the NPV, IRR, and payback period on the graphical interface, responsive user input via the graphical interface.

The multivariate statistical analysis module can be further configured to retrieve, from the market research data store, consumer value assessment data, and to compute a second plurality of coefficients of a second statistical model, for example where each coefficient represents a relative impact of an associated attribute of the target brand on a consumer value assessment represented on the graphical user interface. The second statistical model can comprise a linear regression model, and the consumer value assessment can be represented on the graphical user interface as a dependent variable of the linear regression model, for example comprising a consumer worth-what-is-paid (WWP) response derived from the first market research survey data.

The program instructions can implement a client interface module configured to enable a user to interact with the market share simulation module and the ROI modeling module via a the graphical interface of operating on a client terminal or client device, for example by adjusting one or more of the consumer value assessment data, where changes in the attributes of the target brand are represented on the graphical interface, and the measures of consumer recognition or consumer linkage, where the market share simulation model updates a market share prediction for the target brand on the graphical interface.

A computer program product comprising a tangible, non-transitory computer-readable medium is also encompassed, for example with computer instructions stored thereon which, when executed by a processor, implement a method or system according to any of the above claims.

It will be appreciated that the described embodiments are provided by way of example, for the purpose of teaching the general features and principles of the invention, but should not be understood as limiting the scope of the invention, which is as defined in the appended claims.

1-20. (canceled)

21. A method for predicting a change in market share responsive to a proposed marketing communications campaign associated with a target brand in a target market, implemented in an online system which comprises a marketing analytics server including a processor in communication with a user interface and a market research server including at least one market research data store which is accessible by the processor of the marketing analytics server, the method comprising:
conducting, via the market research server, a first survey of consumers to acquire and store, within the market research data store, first market research survey data relating to rational and emotional drivers of consumer choice in the target market;
retrieving, by the processor of the marketing analytics server, the first market research data from the market research data store;
computing, by the processor of the marketing analytics server, a first plurality of coefficients of a first statistical model corresponding with the first market research survey data, wherein each coefficient represents a relative impact of an associated driver of consumer choice in the target market;
identifying, by the processor of the marketing analytics server, leading drivers of consumer choice from the coefficients of the first statistical model;
communicating, by the processor of the marketing analytics server via the user interface, the leading drivers of consumer choice, whereby proposed marketing communications content may be developed based upon the leading drivers of consumer choice;
conducting, via the market research server, a second survey of consumers exposed to the proposed marketing communications content to acquire and store, within the market research data store, second market research survey data relating to consumer response to the proposed marketing communications content;
retrieving, by the processor of the marketing analytics server, the second market research data from the market research data store;
computing, by the processor of the marketing analytics server, using the first statistical model and second market research survey data, predicted changes in attributes of the target brand corresponding with the leading drivers of consumer choice resulting from the marketing communications content;
computing, by the processor of the marketing analytics server, using the predicted changes in attributes of the target brand and current market share data, a predicted efficacy measure of the marketing communications content in changing market share of the target brand;
computing, by the processor of the marketing analytics server, a modified efficacy measure, based upon the predicted efficacy measure, a measure of communications media efficiency, a measure of consumer recognition of the marketing communications content, and a measure of consumer linkage of the marketing communications content to the target brand;
computing, by the processor of the marketing analytics server, using the modified efficacy measure along with provided financial factor data, one or more measures of commercial outcome from the marketing communications campaign; and
communicating, by the processor of the marketing analytics server via the user interface, the one or more measures of commercial outcome.

22. The method of claim 21 wherein the predicted efficacy measure is a numerical value η, the measure of consumer recognition is a numerical value γᵣ, the measure of consumer linkage of the marketing communications content to the target brand is a numerical value γₗ, the measure of communications media efficiency is a numerical value μₑ, and the modified efficacy is a numerical value η′ which is computed according to the formula:
η′=(η×γᵣ×γₗ)×μₑ.

23. The method of claim 22 wherein the communications media efficiency value μₑ is computed using a media mix modeling algorithm, and further comprising updating, by the processor of the marketing analytics server, the media efficiency value responsive to input, via the user interface, of a change in media spend allocated to one or more media channels of the marketing campaign.

24. The method of claim 21 wherein the first statistical model comprises a hierarchical Bayesian model.

25. The method of claim 24 wherein the consumer choice is represented as a dependent variable of the hierarchical Bayesian model, and comprises a consumer first choice (FC) selection derived from the first market research survey data, the method further comprising communicating, by the processor of the marketing analytics server via the user interface, the consumer FC selection.

26. The method of claim 21 which further comprises:
retrieving, by the processor of the marketing analytics server, consumer value assessment data from the market research data store;
computing, by the processor of the marketing analytics server, a second plurality of coefficients of a second statistical model, wherein each coefficient represents a relative impact of an associated attribute of the target brand on the consumer value assessment data; and
communicating, by the processor of the marketing analytics server via the user interface, the relative impact and associated attribute.

27. The method of claim 26 wherein:
the second statistical model comprises a linear regression model;
the consumer value assessment is represented as a dependent variable of the linear regression model, and comprises a consumer worth-what-is-paid (WWP) response derived from the first market research survey data; and
the method further comprises communicating, by the processor of the marketing analytics server via the user interface, the consumer WWP response.

28. The method of claim 21 wherein the provided financial factor data comprises one or more of weighted average cost of capital (WACC), inflation rate, taxation rates, an investment amount associated with achieving the increase in market share, campaign duration, campaign ramp-up period, and a measure of expected increase in revenues associated with an increase in market share, and wherein the method further comprises one or more of the steps of:
communicating, by the processor of the marketing analytics server via the user interface, the financial factor data; and
updating, by the processor of the marketing analytics server, the financial factor data responsive to user input received via the user interface.

29. The method of claim 21 wherein the measures of commercial outcome from the marketing communications campaign comprise one or more of net present value (NPV), internal rate of return (IRR), and payback period for the marketing communications campaign, wherein the method further comprises one or more of the steps of:
communicating, by the processor of the marketing analytics server via the user interface, one or more of the NPV, IRR, or payback period;
updating, by the processor of the marketing analytics server, a share of media spend allocated to one or more media channels of the marketing communications campaign responsive to user input received via the user interface, and one or more of the NPV, IRR, and payback period resulting from the updated share of media spend; and
communicating, by the processor of the marketing analytics server via the user interface, a recommendation to accept or reject the marketing communications campaign based on one or more of the NPV, IRR, or payback period.

30. A method of predicting changes in market share responsive to a marketing communications campaign associated with a target brand in a target market, implemented in a computing system including a processor in communication with a user interface and a market research data store, the method comprising:
retrieving, by the processor from the market research data store, first market research survey data relating to rational and emotional drivers of consumer choice in the target market;
computing, by the processor, a first plurality of coefficients of a first statistical model corresponding with the first market research survey data, wherein each coefficient represents a relative impact of an associated driver of consumer choice in the target market;
identifying, by the processor, leading drivers of consumer choice from the coefficients of the first statistical model;
communicating, by the processor via the user interface, the leading drivers of consumer choice;
retrieving, by the processor from the market research data store, second market research survey data relating to consumer response to marketing communications content that has been developed based upon the leading drivers of consumer choice;
computing, by the processor, using the first statistical model and second market research survey data, predicted changes in attributes of the target brand corresponding with the leading drivers of consumer choice resulting from the marketing communications content;
computing, by the processor, using the predicted changes in attributes of the target brand and current market share data, a predicted efficacy measure of the marketing communications content in changing market share of the target brand;
computing, by the processor, a modified efficacy measure, based upon the predicted efficacy measure, a measure of communications media efficiency, a measure of consumer recognition of the marketing communications content, and a measure of consumer linkage of the marketing communications content to the target brand;
computing, by the processor, using the modified efficacy measure along with provided financial factor data, one or more measures of commercial outcome from the marketing communications campaign; and
communicating, by the processor via the user interface, the one or more measures of commercial outcome.

31. The method of claim 30 wherein the predicted efficacy measure is a numerical value η, the measure of consumer recognition is a numerical value γᵣ, the measure of consumer linkage of the marketing communications content to the target brand is a numerical value γₗ, the measure of communications media efficiency is a numerical value μₑ, and the modified efficacy is a numerical value η′ which is computed according to the formula:
η′=(η×γᵣ×γₗ)×μₑ.

32. The method of claim 31 wherein the communications media efficiency value μₑ is computed using a media mix modeling algorithm, and further comprising updating, by the processor of the marketing analytics server, the media efficiency value responsive to input, via the user interface, of a change in media spend allocated to one or more media channels of the marketing campaign.

33. The method of claim 30 which further comprises:
retrieving, by the processor from the market research data store, consumer value assessment data;
computing, by the processor, a second plurality of coefficients of a second statistical model, wherein each coefficient represents a relative impact of an associated attribute of the target brand on the consumer value assessment data; and
communicating, by the processor via the user interface, the relative impact and associated attribute.

34. The method of claim 33 wherein:
the second statistical model comprises a linear regression model;
the consumer value assessment is represented as a dependent variable of the linear regression model, and comprises a consumer worth-what-is-paid (WWP) response derived from the first market research survey data; and
the method further comprises communicating, by the processor via the user interface, the consumer WWP response.

35. The method of claim 30 wherein the provided financial factor data comprises one or more of weighted average cost of capital (WACC), inflation rate, taxation rates, an investment amount associated with achieving the increase in market share, campaign duration, campaign ramp-up period, and a measure of expected increase in revenues associated with an increase in market share, and wherein the method further comprises one or more of the steps of:
communicating, by the processor via the user interface, the financial factor data; and
updating, by the processor, the financial factor data responsive to user input received via the user interface.

36. The method of claim 30 wherein the measures of commercial outcome from the marketing communications campaign comprise one or more of net present value (NPV), internal rate of return (IRR), and payback period for the marketing communications campaign, wherein the method further comprises one or more of the steps of:
communicating, by the processor via the user interface, one or more of the NPV, IRR, or payback period;
updating, by the processor, a share of media spend allocated to one or more media channels of the marketing communications campaign responsive to user input received via the user interface, and one or more of the NPV, IRR, and payback period resulting from the updated share of media spend; and
communicating, by the processor via the user interface, a recommendation to accept or reject the marketing communications campaign based on one or more of the NPV, IRR, or payback period.

37. A computing system for predicting changes in market share responsive to a marketing communications campaign associated with a target brand in a target market, the system comprising:
a processor in communication with a user interface;
at least one memory device accessible by the processor; and
at least one market research data store accessible by the processor;
wherein the memory device comprises a non-transitory, computer-readable data storage medium having program instructions stored thereon which, when executed by the processor, cause the computing system to implement a marketing analytics system comprising:
a multivariate statistical analysis module which is configured to retrieve, from the market research data store, first market research survey data relating to rational and emotional drivers of consumer choice in the target market, to compute a corresponding first plurality of coefficients of a first statistical model, wherein each coefficient represents a relative impact of an associated driver of consumer choice in the target market, and to identify leading drivers of consumer choice from the coefficients of the first statistical model;
a test response analysis module which is configured to retrieve, from the market research data store, second market research survey data relating to consumer response to marketing communications content that has been developed based upon the leading drivers of consumer choice, and to use the first statistical model and second market research survey data to compute predicted changes in attributes of the target brand corresponding with the leading drivers of consumer choice resulting from the marketing communications content;
a market share simulation module which is configured to compute, using the predicted changes in attributes of the target brand and current market share data, a predicted efficacy measure of the marketing communications content in changing market share of the target brand;
a return on investment (ROI) modeling module which is configured to compute a modified efficacy measure, based upon the predicted efficacy measure, a measure of communications media efficiency, a measure of consumer recognition of the marketing communications content, and a measure of consumer linkage of the marketing communications content to the target brand, and to use the modified efficacy measure along with provided financial factor data to compute one or more measures of commercial outcome from the marketing communications campaign; and
a client interface module configured for a user to interact with multivariate statistical analysis module, the market share simulation module and the ROI modeling module via the user interface, wherein the leading drivers of consumer choice and the one or more measures of commercial outcome are communicated.

38. The system of claim 37 wherein the predicted efficacy measure is a numerical value η, the measure of consumer recognition is a numerical value γᵣ, the measure of consumer linkage of the marketing communications content to the target brand is a numerical value γₗ, the measure of communications media efficiency is a numerical value μₑ, and the modified efficacy is a numerical value η′ which is computed according to the formula:
η′=(η×γᵣ×γₗ)×μₑ.

39. The system of claim 38 wherein the communications media efficiency value μₑ is computed using a media mix modeling algorithm and wherein:
the client interface module is configured to communicate the communications media efficiency value via the user interface, and to receive user input of a change in media spend allocated to one or more media channels of the marketing campaign; and
the market share simulation module is configured to update the media efficiency value in response to the user input of the change in media spend allocated to one or more media channels of the marketing campaign.

40. The system of claim 37 wherein the measures of commercial outcome from the marketing communications campaign comprise one or more of net present value (NPV), internal rate of return (IRR), and payback period for the marketing communications campaign, and wherein:
the client interface module is configured to communicate one or more of the NPV, IRR, or payback period via the user interface, and to receive user input of an updated share of media spend allocated to one or more media channels of the marketing communications campaign;
the ROI modeling module is configured to update one or more of the NPV, IRR, and payback period resulting from the updated share of media spend; and
the client interface module is configured to communicate a recommendation to accept or reject the marketing communications campaign via the user interface, based on one or more of the NPV, IRR, or payback period.
